(19) United States
(12) Patent Application Publication
(10) Pub. No.: US 2011/0147252 A1
(43) Pub. Date: Jun. 23, 2011

(54) PACKAGES AND INSERTS USEFUL FOR DISPENSING MEDICINES

(75) Inventor: Wail Rasheed, Summit, NJ (US)

(73) Assignee: Schering Corporation, Kenilworth, NJ (US)

(21) Appl. No.: 12/996,567

(22) PCT Filed: Jun. 4, 2009
(86) PCT No.: PCT/US2009/046276

§ 371 Date: Feb. 24, 2011

Related U.S. Application Data
(60) Provisional application No. 61/059,340, filed on Jun. 6, 2008.

(51) Int. Cl. B65D 85/00; B23P 19/00

(52) U.S. Cl. 206/438; 29/428

(57) ABSTRACT

Various embodiments of the present invention provide packages, inserts and pharmaceutical products that are capable of holding a plurality of medicinal units and limiting the amount of medicinal units that are dispensed from the package at one time.

### FIELD OF THE INVENTION

The present invention relates to packages and inserts useful to enable a consumer to dispense a single medicinal unit.

### BACKGROUND

Generally, medicinal units, such as tablets, capsules, caplets, films, gels or the like, are housed in a package, such as a plastic bottle that has an opening which is sufficiently large to accommodate and allow the flow of multiple medicinal units through the opening at one time in order to facilitate filling these containers during packaging line operations. Plastic bottles are inherently cheap and simple to process on packaging lines, making them a commonly used package for oral drug products.

Such packages, however, may render it difficult for consumers to limit dispensing the desired number of medicinal units, particularly when the consumer has limited fine motor abilities. Consumers with limited fine motor abilities include patients, such as the elderly or those with neurological disorders (e.g., Parkinson's disease). Consequently, such patients may undesirably dispense too many medicinal units from a package such as a bottle. Also of concern is spillage from the undesirable dispensing of too many medicinal units which may result whereby one or more medicinal units drops to the floor and becomes lost, irretrievable, or contaminated. This may result in the loss of possibly very expensive medicinal units.

Although there are single unit dose dispensing packages available, for example, blister packs, these packs still present problems. Blister packs or cards containing pharmaceutical unit doses are sold with the blister pack as the primary package which holds the unit doses. During dispensing by patients with neurological disorders such as Parkinson's disease, there is still the problem that a unit dose will drop to the floor or otherwise become lost, irretrievable or contaminated.

Thus, it would therefore be desirable to provide a package containing medicinal unit doses, which limits dispensing of medicinal unit doses one at a time.

### SUMMARY

Various embodiments of the present invention provide packages and inserts that are capable of limiting the amount of medicinal units that are dispensed from the package.

Several embodiments of the present invention provide a package having a container capable of holding a plurality of medicinal units; the container comprising a first opening which is sufficiently large to accommodate the flow of a plurality of medicinal units at one time, a closure for the first opening, and an insert connected with the container in blocking relation to the first opening, the insert having a dispensing opening which is sized to dispense only a single medicinal unit from the container at one time.

The container may have a neck near or at the first opening with the insert located near or at the neck. The insert may be fixedly connected to the neck of the container. The insert may be adapted to be fixedly connected to the container inside or outside of the neck. The insert may be fixed to the neck by a screw fit, a luer lock, friction fit, snap fit, adherence fit, such as a glue or bonding material and the like. Any suitable retention or fixing means may be used. The insert may include a side wall and a bottom wall which closes the side wall, wherein the dispensing opening is provided in the bottom wall. The package may include at least one label and/or instructions for using or dosing the medicinal units.

Other embodiments provide a pharmaceutical product comprising at least one medicinal unit and a package wherein the dispensing opening and the medicinal unit have similar unique shapes and the dispensing opening is slightly larger than the medicinal unit.

Further embodiments provide a package comprising a container capable of holding a plurality of free flowing medicinal units; wherein the container includes a dispensing opening which is sized to dispense a single medicinal unit from the container at one time, and a closure for the dispensing opening. The free flowing medicinal units may be caplets, tablets, capsules and the like.

Still further embodiments of the present invention provide an insert for a package that includes a container capable of holding a plurality of medicinal units; the container comprising a first opening which is sufficiently large to accommodate the flow of a plurality of medicinal units at one time. The insert includes a side wall adapted to be connected with the container, a bottom wall which closes the side wall and which is in blocking relation to the first opening, and a dispensing opening in the bottom wall which is sized to dispense only a single medicinal unit from the container at one time.

Another embodiment provides a pharmaceutical product that includes at least one medicinal unit and a package comprising an insert, wherein the dispensing opening and the medicinal unit have similar unique shapes and the dispensing opening is slightly larger than the medicinal unit.

Still further embodiments provide a method for limiting dispensing of medicinal units to a single medicinal unit at one time from a container that is capable of having a plurality of free flowing medicinal units. The method includes placing an insert into a package that includes a container for holding a plurality of medicinal units. The container includes a first opening which is sufficiently large to accommodate a plurality of medicinal units at one time.

In several embodiments, the packages and/or inserts require minimal changes to the packaging line operation. Packages and inserts desirably require no additional patient usage steps. Packages and/or inserts can be installed in existing stock medicinal containers either during the original packaging operation or the container is filled or as a separate article that is added after a medicinal unit is sold. For instance, an insert may be added to a stock or existing bottle by a pharmacist after such bottle was filled with the medicinal units in the pharmacy. Alternatively, a consumer or caregiver may add the insert to an existing container. In various embodiments, the insert is sized to match accommodate a specific size of medicinal unit. Desirably, the packages and inserts are relatively inexpensive to manufacture and easy to use. In multiple embodiments, a single medicinal unit is dispensed one at a time.

The above and other features of the invention will become readily apparent from the following detailed description thereof which is to be read in connection with the accompanying drawings.

### BRIEF DESCRIPTION OF THE DRAWINGS

FIG. 1 is an exploded perspective view of a package with a cup-shaped insert according to a first embodiment of the present invention;

FIG. 2 is a vertical cross-sectional view of the package and insert of FIG. 1 that includes a closure thereon;

FIG. 3 is a vertical cross-sectional view of the package and insert of FIG. 1 inverted and shown dispensing a single medicinal unit;

FIG. 4 is a vertical cross-sectional view of a funnel-shaped insert according to a second embodiment of the present invention, adapted to fit on the package of FIG. 1;

FIG. 5 is a bottom plan view of the funnel-shaped insert of FIG. 4;

FIG. 6 is an exploded perspective view of a package according to another embodiment of the present invention;

FIG. 7 is a vertical cross-sectional view of the package of FIG. 6 that includes a closure thereon;

FIG. 8 is a perspective view of a package according to another embodiment of the present invention.

### DETAILED DESCRIPTION

Several embodiments of the present invention provide a package comprising a container capable of holding a plurality of medicinal units. Such containers may be stock containers that house medicinal units such as pharmaceutical products including tablets, caplets, capsules and the like. The container may have a first opening which is sufficiently large to accommodate the flow of a plurality of medicinal units at one time. This allows such containers to be easily filled with medicinal units on a production filling machine or by a pharmacist. The container may have a closure for the first opening. An insert is connected with the container in blocking relation to the first opening, the insert having a dispensing opening which is sized to dispense only a single medicinal unit from the container at one time.

In several embodiments, the packages and/or inserts require minimal changes to the packaging line operation. Packages and inserts desirably require no additional patient usage steps. Packages and/or inserts can be installed in existing stock medicinal containers either during the original packaging operation or the container is filled or as a separate article that is added after a medicinal unit is sold. For instance, an insert may be added to a stock or existing bottle by a pharmacist after such bottle was filled with the medicinal units in the pharmacy. Alternatively, a consumer or caregiver may add the insert to an existing container. In various embodiments, the insert is sized to match accommodate a specific size of medicinal unit. Desirably, the packages and inserts are relatively inexpensive to manufacture and easy to use. In multiple embodiments, a single medicinal unit is dispensed one at a time.

In certain embodiments, the container includes a neck with a first opening therein, wherein the insert is connected with the neck. The container, package or the insert may include an arrangement for preventing the insert from falling into the container. Arrangements may include a lip on the insert which engages the neck, the insert may engage a shoulder on the neck, the insert may be connected outside of the neck and/or the insert can be fixed to the neck.

The insert may include a side wall and a bottom wall which closes the side wall, wherein a second or dispensing opening is provided in the bottom wall. In certain embodiments, the side wall has similar dimensions to the container neck. In other embodiments, the insert has a cup shape.

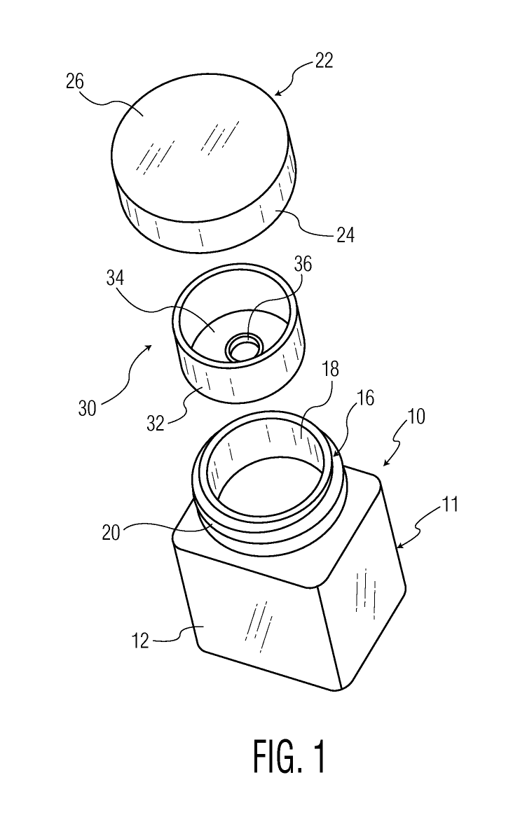

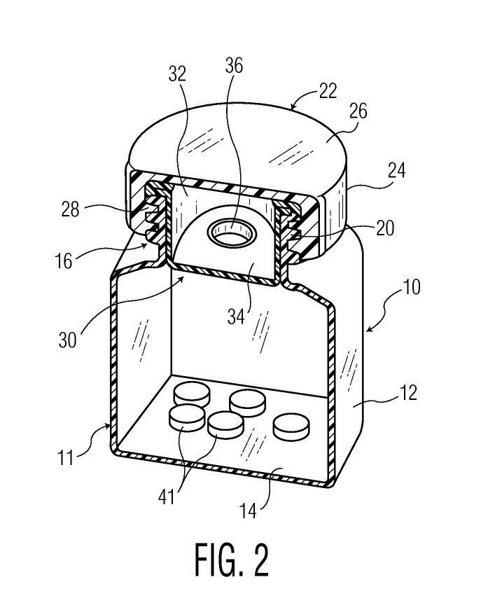

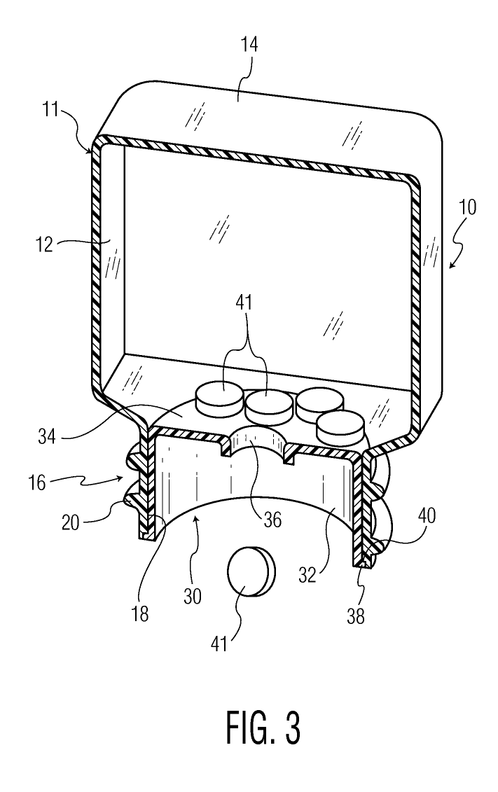

Referring to the drawings in detail, and initially to FIGS. 1-3 thereof, a package 10 with which the present invention is used, includes a container 11 having a side wall 12 and a bottom wall 14 which closes the lower end of side wall 12, an opening 18, referred to as the first opening, which is sufficiently large to accommodate the flow of a plurality of medicinal units, and a closure 22 for removably closing opening 18. The package can be any suitable shape such as a boxed shape, cylindrical shape, triangular shape, rounded shape, etc. Likewise, the package can be made out of any suitable material, including glass, plastic, metal, and the like. In one embodiment, the package is a bottle and the closure is a cap with a child resistant feature.

The closure 22 can be completely removed from opening 18 or removably connected with an appropriate swivel, latch, or hinge mechanism. Preferably, closure 22 includes a child resistant feature. In certain embodiments, the closure 22 has a side wall 24 and a top wall 26 that closes the upper end of side wall 24.

In certain embodiments, the container 11 has a neck 16 at the upper end of the container side wall 12, which has an opening 18 therein, referred to as the dispensing opening. In one embodiment, the outer surface of neck 16 also includes threads 20 thereon. In certain embodiments, internal threads 28 are provided on the inner surface of closure side wall 24 for threadedly engaging with threads 20 in a conventional manner.

In accordance with the present invention, insert 30 is specially adapted for use with container 11 of package 10. Insert 30 is connected with container 11 in blocking relation to opening 18 and includes a bottom wall 34 which closes the lower end of side wall 32 and which is in blocking relation to opening 18, and dispensing opening 36 in the bottom wall 34 which is sized such that it is just large enough to permit a single medicinal unit 41 to pass easily therethrough, thereby limiting dispensing to only a single medicinal unit from the container at one time. The bottom wall 34 can be any suitable shape, including, but not limited to, planar or curved (e.g., convex). In one embodiment, the insert includes a side wall 32 adapted to be connected with the container 11, which is closed by a closure wall. In one embodiment, the side wall 32 has similar dimensions to neck 16, although the present invention is not limited thereby.

In one embodiment, insert 30 fits within neck 16. Insert 30 can be secured in neck 16 in any number of ways. Any suitable means for fixing the insert to the container may be utilized, such as, but not limited to screw fit, a luer lock fit, friction fit, snap fit, welding, chemically adherence and the like. For example, insert 30 can be friction fit in neck 16. In order to prevent insert 30 from falling into the container 11 of package 10, a lip 38 can be provided at the upper edge of side wall 32, which seats on a cut-out shoulder 40 at the upper edge of neck 16. Lip 38 can be formed as an extension of insert side wall 32. It will be appreciated that any other limiting arrangement can be used, including, for example, ledges, grooves, channels, etc. Alternatively, or in addition to, insert 30 can be adhered, ultrasonically welded or the like to neck 16.

It will also be appreciated that, while insert 30 has been discussed as being inserted into neck 16, insert 30 can be formed integrally in a single molding operation with neck 16 as well. In such instance, for example, filling of container 11 can occur through an open bottom, with bottom wall 14 being ultrasonically welded thereon after container 11 is filled.

Thus, insert 30 modifies package 10 to provide a modified opening (i.e., dispensing opening 36) that allows only a single medicinal unit 41 to be dispensed with minimal changes to the packaging line operation and no additional patient usage steps. Further, it will be appreciated that insert 30 can be installed during the original manufacturing operation, or can be inserted after the filled package 10 is sold, thereby causing minimal changes to the packaging line operation. In one embodiment, opening 18 is a wide opening thereby retaining the desired processing characteristics of a wide mouthed package. Still further, the size of dispensing opening 36 can be varied according to the specific size of the medicinal unit 41 to be dispensed.

In addition, with insert 30 limiting dispensing to a single medicinal unit 41 at one time, it is believed that patients are more likely to be compliant with the dosage requirements. Also, the probability that the single medicinal unit 41 will be contaminated by dropping on the floor as may occur when a plurality of medicinal units are undesirably dispensed at one time is reduced. Further, the child resistant feature on closure 22 can remain functional with insert 30 inserted in place. Senior friendly closures may also be used.

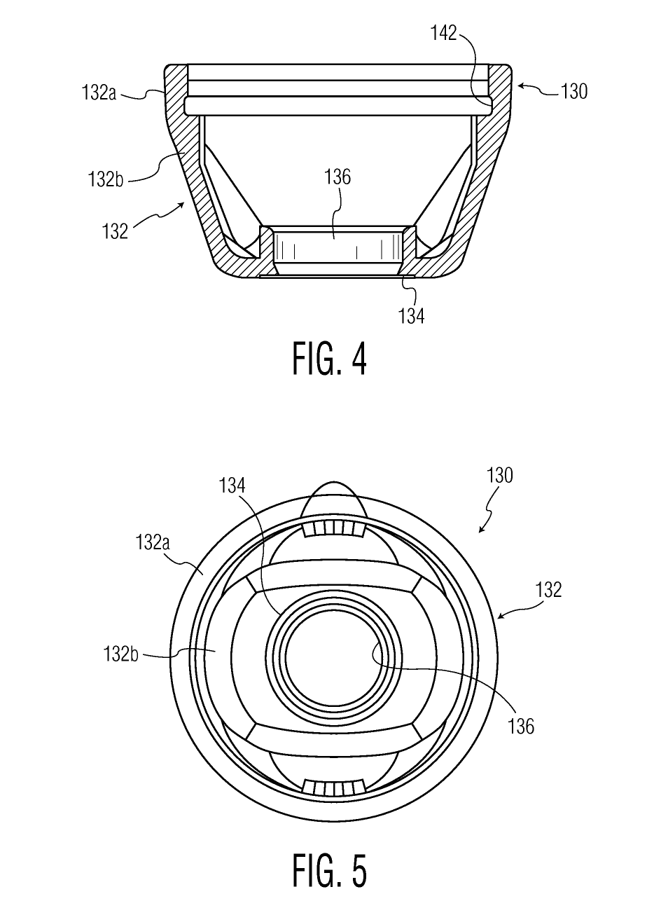

Referring now to FIGS. 4 and 5, an insert 130 according to another embodiment of the present invention will now be described in which elements corresponding to those of insert 30 are identified by the same reference numerals, but augmented by A 100″, and a detailed description of the common elements will be omitted for the sake of brevity.

In several embodiments the insert can have a funnel shape. Specifically, side wall 132 of insert 130 includes an upper wall section 132a which then tapers down in a frusto-conical wall section 132b, the lower end of which is closed by a bottom wall 134 having dispensing opening 136 therein that is just large enough to permit only a single unit 41 to pass easily therethrough.

Upper wall section 132a of insert 130 can be friction fit in neck 16. Alternatively, or in addition to, insert 130 can be adhered, ultrasonically welded or the like to neck 16.

It will be appreciated that, although insert 130 has been described as being fit within neck 16, it can also be arranged to fit over neck 16. In this regard, upper wall section 132a can include an inner groove 142 which receives a thread 20 on neck 16. In such case, closure 22 can merely seat on insert 130, or alternatively, the outer surface of upper wall section 132a of insert 130 can be provided with threads (not shown) for threadedly receiving closure 22.

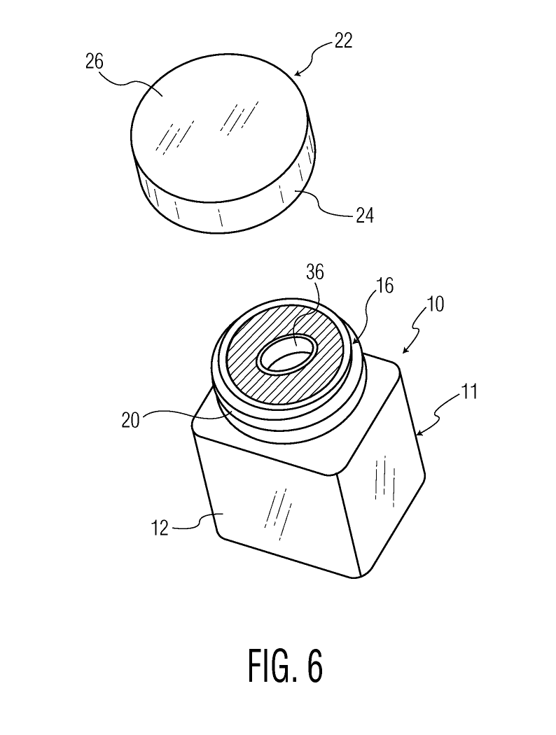

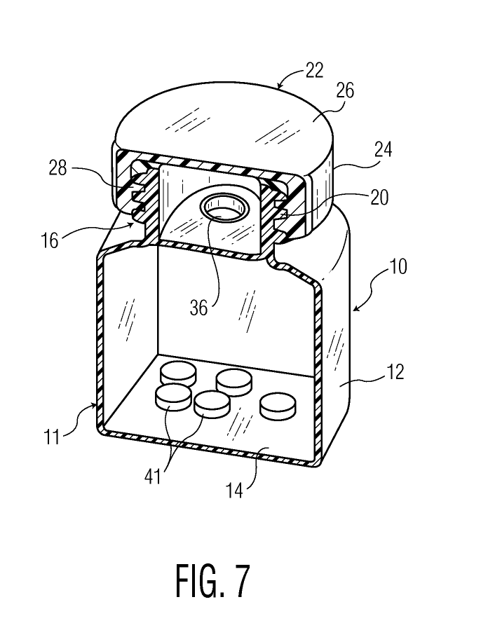

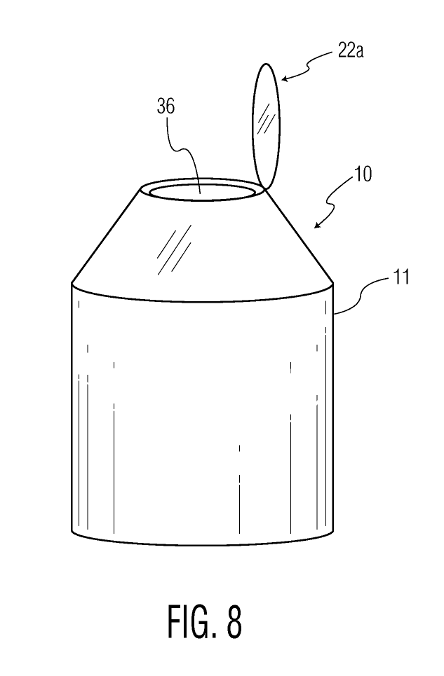

Referring now to FIGS. 6 and 8 (as well as FIG. 7 which is a vertical cross-sectional view of FIG. 6), there are shown packages according to other embodiments of the present invention. Package 10 may include a container 11 for holding medicinal units having a dispensing opening 36 which is sized to dispense only a single medicinal unit from the container at one time, and a closure 22 for the dispensing opening. It will be appreciated that dispensing opening 36 can be formed with container 11 as a single molded top. It will also be appreciated that filling of container 11 can occur through an open bottom, with bottom wall 14 being ultrasonically welded thereon after container 11 is filled. The package can be any suitable shape such as a boxed shape, cylindrical shape, triangular shape, rounded shape, etc. Likewise, the package can be made out of any suitable material, including glass, plastic, metal, and the like. In one embodiment, the package is a bottle and the closure is a cap with a child resistant feature.

Closure 22 can be completely removed from dispensing opening 36 or removably connected with an appropriate swivel, latch, or hinge mechanism, such as closure 22a as shown in FIG. 8. Preferably, closure 22 includes a child resistant and/or a senior friendly feature. In certain embodiments, the closure 22 has a side wall 24 and a top wall 26 that closes the upper end of side wall 24.

In certain embodiments, the container 11 has a neck 16 at the upper end of the container side wall 12, which preferably has dispensing opening 36 therein. In one embodiment, the outer surface of neck 16 also includes threads 20 thereon. In certain embodiments, internal threads 28 are provided on the inner surface of closure side wall 24 for threadedly engaging with threads 20 in a conventional manner.

It will be appreciated that reference to medicinal units is intended to encompass dispensing of tablets, capsules, caplets, etc.

Other embodiments of the present invention provide for a label on the package. Such labeling could identify the type of drug contained in the package. Suitable labels include weeks, days of the week or indications within a day such as nighttime/PM or morning/AM that would be in accordance with the desirable dosing regimens of the particular medicament(s) contained therein. Suitable labeling could also include directions for placing the insert in the package.

An additional embodiment of the present invention provides methods for limiting dispensing of medicinal units by an end user to a single medicinal unit at one time including the step of providing any of the aforementioned packages or inserts of the present invention to the end user. In one embodiment, the risk of an end user dropping a single medicinal unit is reduced. In one embodiment, the end user is a patient with a neurological disease.

Having described various embodiments of the invention with reference to the accompanying drawings, it will be appreciated that the present invention is not limited to those precise embodiments and that various changes and modifications can be effected therein by one of ordinary skill in the art without departing from the scope or spirit of the invention as defined by the appended claims.

1. A package comprising:
a container capable of holding a plurality of medicinal units; the container comprising a first opening which is sufficiently large to accommodate the flow of a plurality of medicinal units at one time,
a closure for the first opening, and
an insert connected with the container in blocking relation to the first opening, the insert having a dispensing opening which is sized to dispense only a single medicinal unit from the container at one time.

2. A package according to claim 1, wherein the container comprises a neck near or at the first opening, and the insert is located near or at the neck.

3. A package according to claim 2, wherein the insert is fixedly connected to the neck of the container.

4. A package according to claim 2, wherein the insert is adapted to be fixedly connected to the container outside of the neck.

5. An insert according to claim 2 wherein the insert is adapted to be fixedly connected to the container inside of the neck.

6. A package according to claim 2, wherein the insert is fixed to the neck by screw fit, a luer lock fit, friction fit, snap fit or chemical adherence.

7. A package according to claim 1, wherein the insert includes a side wall and a bottom wall which closes the side wall, wherein the dispensing opening is provided in the bottom wall.

8. A package according to claim 1, wherein the package includes at least one label; and/or instructions for using or dosing the medicinal units.

9. A pharmaceutical product comprising at least one medicinal unit and the package according to claim 1, wherein the dispensing opening and the medicinal unit have similar unique shapes and the dispensing opening is slightly larger than the medicinal unit.

10. A package comprising:
a container capable of holding a plurality of free flowing medicinal units; the container comprising a dispensing opening which is sized to dispense a single medicinal unit from the container at one time, and
a closure for the dispensing opening.

11. A package according to claim 11, wherein the package includes at least one label; and/or instructions for using or dosing the medicinal unit.

12. A pharmaceutical product comprising at least one medicinal unit and a package according to claim 10, wherein the dispensing opening and the medicinal unit have similar unique shapes and the dispensing opening is slightly larger than the medicinal unit.

13. An insert for a package comprising a container capable of holding a plurality of medicinal units; the container comprising a first opening which is sufficiently large to accommodate the flow of a plurality of medicinal units at one time; the insert comprising:
a side wall adapted to be connected with the container,
a bottom wall which closes the side wall and which is in blocking relation to the first opening, and
a dispensing opening in the bottom wall which is sized to dispense only a single medicinal unit from the container at one time.

14. A pharmaceutical product comprising at least one medicinal unit and a package comprising an insert according to claim 13, wherein the dispensing opening and the medicinal unit have similar unique shapes and the dispensing opening is slightly larger than the medicinal unit.

15. A pharmaceutical product according to claim 14, wherein the container comprises a neck near or at the first opening and the insert is located at or near the neck.

16. A pharmaceutical product according to claim 14, wherein the insert is adapted to be connected to the neck.

17. A pharmaceutical product according to claim 14, wherein the insert is fixed to the neck by screw fit, a luer lock fit, friction fit, snap fit or chemically adherence.

18. A pharmaceutical product according to claim 14, wherein the insert comprises a lip which is adapted to engage the neck.

19. A pharmaceutical product according to claim 14, wherein the insert is adapted to be fixedly connected to the outside of the neck.

20. (canceled)

21. A method for limiting dispensing of medicinal units to a single medicinal unit at one time from a container comprising a plurality of free flowing medicinal units; the method comprising placing an insert of claim 13 into a package comprising a container capable of holding a plurality of medicinal units; the container comprising a first opening which is sufficiently large to accommodate the flow of a plurality of medicinal units at one time.
